(19) United States
(12) Patent Application Publication
(10) Pub. No.: US 2019/0116744 A1
(43) Pub. Date: Apr. 25, 2019

(54) Autonomous Irrigation System

(71) Applicant: AQUALONE, NOUMEA cedex (FR)

(72) Inventor: Bernard Balet, 98857 Noumea Cedex (NC)

(21) Appl. No.: 15/770,073

(22) PCT Filed: Oct. 24, 2016
(86) PCT No.: PCT/FR2016/052759

§ 371 Date: Apr. 20, 2018

(30) Foreign Application Priority Data
Oct. 22, 2015 (FR) 1560053
Mar. 14, 2016 (FR) 1652092

(51) Int. Cl. A01G 25/16; A01G 27/00

(52) U.S. Cl. CPC A01G 25/167; A01G 27/003

(57) ABSTRACT

The invention relates to an autonomous device for spraying a medium to be sprayed, containing: a control tank; a valve that can switch from a closed position to an open position and vice versa, according to the filling level of the control tank; and a porous ceramic wall that can be in contact with the medium to be sprayed and separates the control tank from said medium to be sprayed, the ceramic being structured so as to drain a spray liquid between the medium to be sprayed and the control tank. The invention also relates to an autonomous device for controlling the spraying.

### FIELD OF THE INVENTION

The invention relates to the watering of an environment, such as land devoted to agriculture or to horticulture and more generally any land requiring a watering.

### BACKGROUND OF THE INVENTION

Customarily, in order to save on water intended for the watering of an environment, the latter is divided into at least two distinct zones. Then one waters in sequence each zone. To do this, a valve is installed between a water inlet and each watering means, which may be for example a sprinkler, of a zone. Thus, it is necessary to determine, especially as a function of the hygrometric conditions, on the one hand when it is necessary to water one of the zones and on the other hand the duration of the watering sequence.

Generally an electric programmer is used, connected to an electric valve for each zone being watered. Based on the known average hygrometrical data for the region, an operator adjusts the programmer so as to water each zone at predetermined times and for predetermined durations.

Thus, the watering of a zone takes place at predetermined times and for predetermined durations. This is why it is possible, for example in case of an exceptional rain event, for a zone to be watered when such is not needed. On the other hand, for example in case of unusual drought, it is possible for the zone to not be watered, or not watered sufficiently, even though it requires this. In such cases, the operator himself needs to initiate the watering by modifying the settings of the programmer.

### SUMMARY OF THE INVENTION

One purpose of the invention is to provide an autonomous watering control device which is able to initiate a watering sequence only when the environment so requires.

To accomplish this, according to the invention an autonomous device for watering of an environment to be watered is provided, characterized in that it comprises:
a control tank,
a valve that can switch from a closed position to an open position and vice versa, according to the filling level of the control tank, and
a porous ceramic wall that can be in contact with the environment to be watered and separating the control tank from said environment to be watered, the ceramic being structured so as to drain a watering liquid between the environment to be watered and the control tank.

The porous ceramic wall ensures a correlation between the content of watering liquid of the environment to be watered and the quantity of liquid present in the control tank.

The device according to the invention is thus able to initiate a watering sequence only when the environment so requires. The hygrometrical state of the control tank is thus a faithful reflection of that of the environment to be watered. This characteristic thus makes it possible to initiate a watering sequence when the environment to be watered so requires and also to halt the watering sequence when the environment to be watered is sufficiently wet.

The device of the invention may furthermore comprise the following characteristics, taken alone or in combination with each other:
it comprises means of evacuation of the watering liquid from the control tank. The means of evacuation of the watering liquid from the control tank make it possible to adjust the time elapsed between the initiating of two watering sequences independently of the hydrological state of the environment to be watered. Thus, one may adjust the duration of a watering sequence and the interval of time elapsed between two watering sequences. In particular, it is possible to reduce the time elapsed between two watering sequences, which is desirable for example when the control tank contains a substrate which is particularly draining, such as coconut fiber, rock wool, or sand.
the means of evacuation of the watering liquid from the control tank are able to evacuate the watering liquid from the control tank when the volume of watering liquid in the control tank exceeds a predetermined filling threshold.
it comprises means enabling a regulating of the predetermined filling threshold of watering liquid in the control tank. It is thus the operator who simply adjusts the interval of time elapsed between two watering sequences.
the means of evacuation of the watering liquid from the control tank comprise a pipe.
the means of evacuation of the watering liquid from the control tank comprise a siphon.
the siphon comprises a material able to drain the watering liquid by capillarity. These means make it possible to easily evacuate the watering liquid from the control tank.
a difference in altitude between two ends of the siphon is controllable. One may thus adjust the flow rate of the watering liquid from the tank.
the flow rate of the watering liquid leaving the siphon is adjustable, by clamping or squeezing means, for example controlled by an adjustment screw.
the porous ceramic wall forms a container that can receive the environment to be watered. This is a simple layout to collect the watering liquid and guarantee that the content of watering liquid of the environment to be watered is strictly tied to the quantity of watering liquid in the control tank.
the container and the valve are disposed side by side and are preferably at the same height and aligned in a horizontal direction. The device thus has a very small footprint. One dimension, in a vertical direction, of the device is relatively slight, preferably less than 10 cm, although the device may also be buried and thus invisible.
the valve is a magnetic control valve comprising a ferromagnetic needle and a magnet attached to a float. The magnetic control makes it possible to do without any electrical means. In fact, in the devices of the prior art, the electrical programmer is connected to the electrical valve by electrical cables. Now, electrical cables and electric energy in general are poorly suited to the presence of water.
the valve comprises a case to hold the ferromagnetic needle and the control tank comprises a sheath that can receive the case while serving as a guide for the sliding of the float.
the control tank comprises a wall which supports the container and forms the sheath which lodges the case. Thus, one limits as much as possible the footprint of the autonomous device for watering.
the sheath has an air evacuation orifice. Thus, it is ensured that the air present in the control tank is properly evacuated and does not cause a displacement of the float. This characteristic, although described in combination with the porous wall, could be the subject matter of a separate patent protection, since it can be implemented independently of the material making up the wall separating the control tank from the environment to be watered.
the control tank is designed to evacuate rain water. The reliability of the device is thus improved. Moreover, the autonomy of the device is increased, since the operator himself does not need to evacuate the rain water. This characteristic, although described in combination with the porous wall, could be the subject matter of a separate patent protection, since it can be implemented independently of the material making up the wall separating the control tank from the environment to be watered.
the device comprises a watering duct disposed between an outlet of the valve and the container, and preferably the watering duct comprises a dripper whose outlet flow rate is adjustable. The dripper allows the operator to determine, if so desired, a minimal watering time. If the dripper is closed, the watering liquid is never sent to the container and the need for water is considered to be continual. Thus, the watering will also be continual. On the other hand, if the dripper is adjusted at its maximum flow rate, the container will be quickly filled and the end of watering condition will be quickly reached. Between these two extreme configurations, the dripper is able to insert a greater or lesser interval between the change in the hydrological conditions of the environment to be watered and the hydrological conditions of the sample. In other words, the adjustment of the flow rate of the dripper makes it possible to set the duration of each watering period. Moreover, in the case of an outdoor watering, when the dripper is closed only an external water supply for the element measuring the need for watering, such as a rainy episode, can initiate the end of the watering. The presence of the dripper, although described in combination with the preceding invention, could be the subject matter of a separate patent protection, since it can be implemented independently of the material making up the wall separating the control tank from the environment to be watered.

Furthermore, the invention provides a solution for the watering of large-scale facilities in which it is necessary to control a watering control valve at an elevated flow rate.

For this purpose, the invention also relates to an autonomous device for controlling the watering, characterized in that it comprises:
a fluidic control valve that can occupy a closed position in which the watering is prevented and an open position in which the watering is enabled, depending on the flow rate of a watering liquid in a control outlet of said fluidic control valve,
an autonomous device for watering as described above, applied to a control sample of the environment to be watered, fed by the control outlet of the fluidic control valve.

Thus, since the device may contain a control sample of the environment to be watered, it has information as to the need for watering which is representative of the hydrological conditions of this environment. Consequently, the autonomous device for watering of the control sample can move the watering control valve from the closed position to the open position and vice versa, according to the watering need of the control sample, so as to start or stop the watering of the entire environment to be watered. Thus, the environment is watered when a watering needs to be performed and only for the required duration. The device is thus both autonomous and saves on watering liquid.

Furthermore, when a siphon as described above is present in the autonomous watering control device, one may reduce the time elapsed between two watering sequences in order to organize a multitude of short watering sequences as are required by certain plants or certain types of crops, such as soilless or hydroponic cultivation. The device is thus both autonomous and adaptable and saves on watering liquid.

It will be noted furthermore that one may replace the fluidic control valve with any suitable valve type. In particular, a hydraulic or electric control valve or a pneumatic control valve.

Preferably, the autonomous device for watering comprises a watering duct and the autonomous device for controlling the watering comprises a watering rate maintaining duct, situated between the watering duct and a watering flow outlet duct of the fluidic control valve.

In this way, it is ensured that the watering flow rate is little impacted by the flow rate of the sampling duct, even if a dripper adjusted to its minimal flow rate limits the flow of liquid in the watering duct.

This characteristic, although described in combination with the porous wall, could be the subject matter of a separate patent protection, since it can be implemented independently of the material making up the wall separating the control tank from the environment to be watered.

### BRIEF DESCRIPTION OF THE DRAWINGS

There shall now be described, in nonlimiting manner, three embodiments of the invention, with the aid of the following figures:

FIG. 1 is a cross sectional view of an autonomous watering control device according to a first embodiment,

FIG. 2 is a cross sectional view of a magnetic control valve of the device of FIG. 1, in closed position,

FIG. 3 is a view analogous to that of FIG. 2, in which the magnetic control valve is in open position,

FIG. 4 is a cross sectional view of an autonomous watering control device according to a second embodiment of the invention, and

FIG. 5 is a cross sectional view of an autonomous watering control device according to a third embodiment of the invention.

### DETAILED DESCRIPTION OF THE INVENTION

In the present description, the watering liquid is water. Thus, one uses the word “water” to designate this liquid, but the invention is not limited to this watering liquid alone.

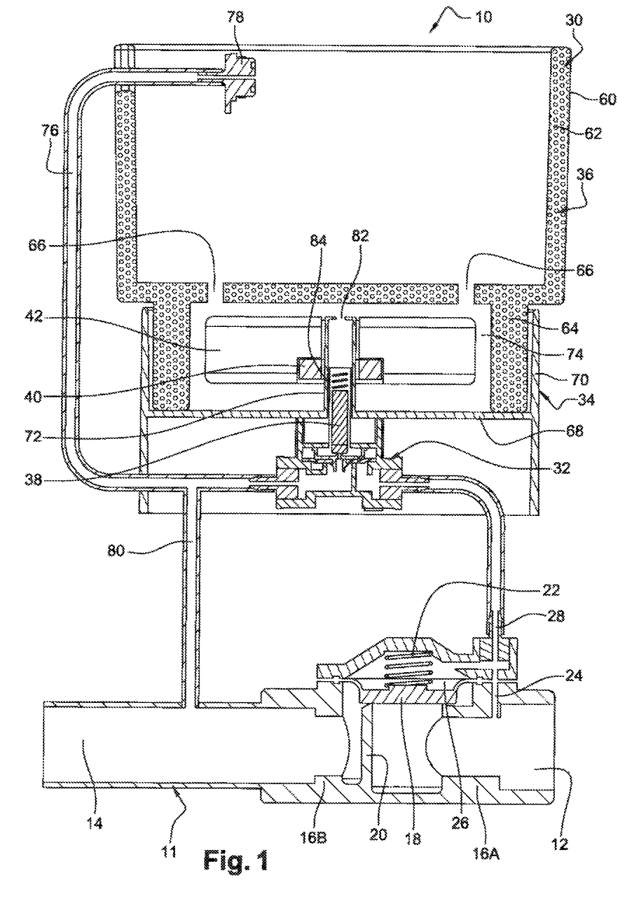

There is represented, in FIG. 1, an autonomous watering control device 10. Here, the autonomous watering control device 10 is designed to water an environment such as a farming soil, with water.

The autonomous watering control device 10 comprises:
a fluidic control valve 11 and
an autonomous device for watering 30.

The autonomous device for watering 30 comprises:
a control tank 34,
a magnetic control valve 32 able to move from a closed position to an open position and vice versa, according to the filling level of the control tank 34, and
a porous ceramic wall 36, able to be in contact with the environment to be watered and separating the control tank 34 from said environment to be watered, the ceramic being structured to drain a watering liquid between the environment to be watered and the control tank 34.

The fluidic control valve 11 comprises a fluid inlet 12 and a fluid outlet 14. The fluid inlet 12 and the fluid outlet 14 are also the fluid inlet and outlet for the autonomous watering control device 10. The fluid inlet 12 is connected to a water intake (not shown) and the fluid outlet 14 is connected to a water outlet (not shown), such as a sprinkler, able to water the farming soil.

Between the fluid inlet 12 and the fluid outlet 14, the fluidic control valve 11 comprises an upstream duct 16A and a downstream duct 16B, which are formed here as a single piece with the inlet 12 and the outlet 14, although this is in no way limiting.

Between the upstream duct 16A and the downstream duct 16B, a tight membrane 18 rests against a seat 20. A spring 22 pushes the tight membrane 18 against its seat 20. In a branch from the upstream duct 16A, a duct 24 leads to a chamber 26 delimited by the tight membrane 18 and in which the spring 22 is disposed. Moreover, the duct 24 is connected to a control outlet 28 of the fluidic control valve 11.

Moreover, the autonomous watering control device 10 comprises the autonomous device for watering 30. This autonomous device for watering 30 comprises a magnetic control valve 32, a control tank 34 and a porous ceramic wall 36.

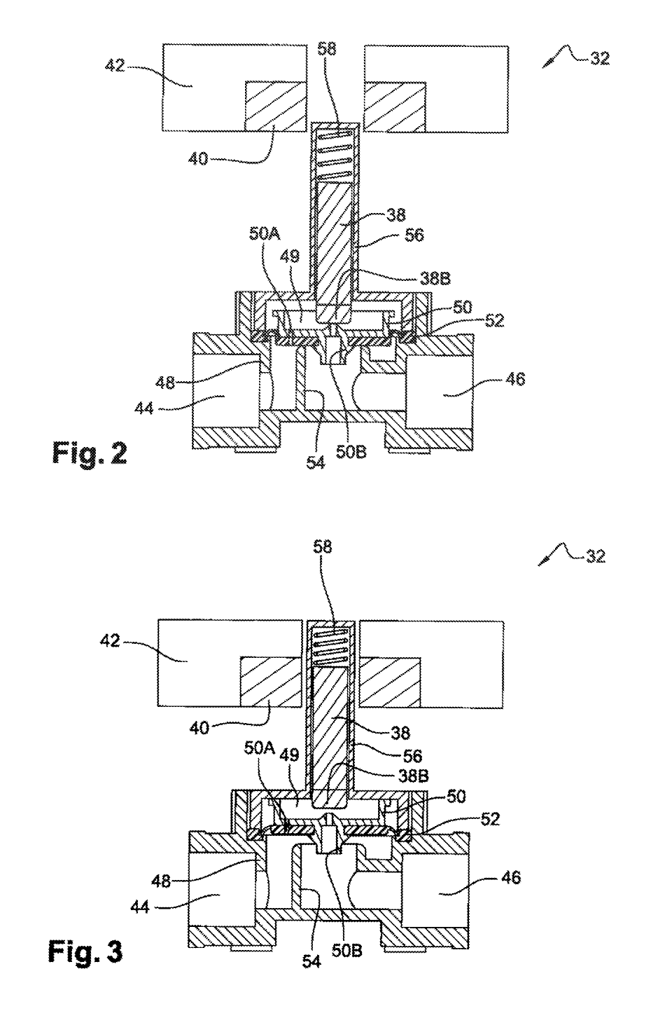

The magnetic control valve 32, represented in more detail in FIGS. 2 and 3, comprises a ferromagnetic needle 38 able to move by axial translation in a case 56, a magnet 40 attached to a float 42, a fluid inlet 44, a fluid outlet 46, a fluid circulation duct 48 connecting the fluid inlet 44 and outlet 46, and a shutter formed by a shutter cup 50 coupled to an annular sealing membrane 52, whose periphery is clamped in the wall of the fluid circulation duct 48. The membrane delimits, above the fluid circulation duct 48, a pressure chamber 49. The shutter, that is, the cup 50 coupled to the membrane 52, is able to move by translation in the axial direction of the needle and the membrane 52 rests against a seat 54, in one of the end travel positions of the shutter.

Moreover, a spring 58, arranged in the case 56, exerts pressure on the ferromagnetic needle 38 so that the latter bears against the shutter cup 50 and applies the sealing membrane 52 against the seat 54, so as to prevent the watering liquid coming from the fluid inlet 44 from reaching the fluid outlet 46.

The shutter cup 50 and the sealing membrane 52 comprise:
a first pressure equalizing duct 50A of small diameter which establishes a fluidic communication between the lower and upper faces of the sealing membrane 52, that is, between the fluid inlet 44 and the pressure chamber 49; and
a second pressure equalizing duct 50B of larger diameter than the first pressure equalizing duct 50A, which establishes a fluidic communication between the lower and upper faces of the sealing membrane 52, that is, between the pressure chamber and the fluid outlet 46. This second duct is situated opposite a lower end (in relation to the drawing) of the ferromagnetic needle 38. When the ferromagnetic needle bears against the shutter cup 50, its lower end 38B plugs the second pressure equalizing duct 50B, if not hermetically then at least so as to reduce its clearance so that the flow rate of watering liquid through this second pressure equalizing duct 50B becomes less than the flow rate of watering liquid in the first pressure equalizing duct. On the contrary, when the needle is distant from the shutter cup 50, the watering liquid may pass through the second pressure equalizing duct at a flow rate greater than the flow rate of watering liquid through the first pressure equalizing duct 50A.

As can be seen in FIG. 2, when the magnet 40 is positioned at a distance from the ferromagnetic needle 38, the return force of the spring 58 predominates and the second pressure equalizing duct 50B is plugged by the lower end 38B of the ferromagnetic needle 38. The shutter membrane 50 is thus subjected on its lower and upper faces to the pressure of the watering liquid present in the fluid inlet 12, but since the quantity of watering liquid which can enter into the pressure chamber 49 (by the first duct 50A) is greater than the quantity of watering liquid which can leave the pressure chamber 49 (by the second duct 50B), the pressure which prevails above the membrane is greater than that which prevails below and the membrane is applied against its seat. The watering liquid thus cannot circulate from the fluid inlet 44 to the fluid outlet 46. This position of closure is stable, since the pressure difference is increased if the fluid outlet 46 remains open, because the lower surface of the membrane delimited by the seat 54 is no longer subjected to the pressure of the watering liquid.

On the contrary, as shown in FIG. 3, when the magnet 40 is near the upper end of the ferromagnetic needle 38, the force of attraction of the magnet 40 predominates over the return force of the spring 58 and attracts the ferromagnetic needle 38. Said needle 38 moves away from the shutter cup 50 and frees up the second pressure equalizing duct 50B. The quantity of watering liquid which can enter the pressure chamber 49 then becomes less than the quantity of watering liquid able to leave said pressure chamber 49, so that the pressure drops in the pressure chamber 49 and the membrane is detached from its seat. Thus, the watering liquid can pass through the magnetic control valve 32.

The control tank 34 is the upper portion 74 of a cylindrical body formed by a horizontal wall 68 and a lateral wall 70 which extends along the perimeter of the bottom 68. The lower portion of the cylindrical body lodges the magnetic control valve 32.

Moreover, the control tank 34 comprises, at its center, a sheath 72 which can accommodate the case 56 of the ferromagnetic needle 38 and which serves as a guide for the float 42 containing the magnet 40, for its sliding by translation along a vertical direction.

Finally, the autonomous device for watering 30 comprises the porous ceramic wall 36, which forms an envelope 60 that surrounds and makes contact with a control sample 62 of the environment to be watered, here, a sample of the farming soil. The porous ceramic making up the wall 36 has a mass by volume between 1.5 and 2 g/cm³, a crushing resistance of at least 15 MPa, a hardness at least equal to 5 Mohs, a water absorption capacity of at least 25 vol. %, a porosity at least equal to 40%, and it has pores with a diameter between 10 and 500 μm. The control sample 62 is a portion of the farming soil at the surface or at a greater depth. Moreover, the envelope 60 has the shape of a pot or a container provided with a supporting rib 64 of revolution which fits into the control tank 34. It also comprises, on its lower horizontal face, two orifices 66 whose function shall be described later on.

The autonomous device for watering 30 comprises a watering duct 76 disposed at the outlet 46 of the magnetic control valve 32. In this embodiment, a dripper 78 is positioned at the other end of the watering duct 76, inside the pot formed by the envelope 60.

Moreover, the autonomous watering control device 10 has a watering flow maintaining duct 80 which is disposed in a branch from the watering duct 76 to the fluidic control valve 11.

We shall now describe the functioning of the autonomous watering control device 10, making reference to FIG. 1.

The control outlet 28 of the fluidic control valve 11 is connected to the fluid inlet 44 of the magnetic control valve 32. Thus, it is the magnetic control valve 32 which controls the opening and the closing of the fluidic control valve 11. In fact, when the fluid outlet 46 of the magnetic control valve 32 is closed, the watering liquid coming from the fluid inlet 12 of the autonomous watering control device 10 flows into the chamber 26 of the fluidic control valve 11 where it exerts a pressure on the membrane 18 so as to close the fluidic control valve 11. On the contrary, when the fluid outlet 46 of the magnetic control valve 32 is open, the pressure of the watering liquid in the chamber 26 of the fluidic control valve 11 drops, resulting in the opening of the fluidic control valve 11. In this latter configuration, the watering liquid coming from the fluid inlet 12 of the autonomous watering control device 10 can again reach the fluid outlet 14 of the autonomous watering control device 10. The watering liquid thus flows into the fluidic control valve 11 from the water intake, such as a reservoir (not shown) intended for the irrigation of the soil, and up to the water outlet, such as a sprinkler (not shown), in order to water the agricultural soil.

Thus, it is the magnetic control valve 32 which controls the start and end of the flow in the fluidic control valve 11 and thus the start and end of a watering sequence. The magnetic control valve 32 is thus able to occupy a closed position, in which the watering is prevented, and an open position, in which the watering is enabled.

During a watering sequence, the magnetic control valve 32 is in the open position. In this case, the watering duct 76, which is connected to the outlet 46 of the magnetic control valve 32, empties watering liquid through the dripper 78 into the control sample 62 of the environment contained by the wall 36. The control sample 62 absorbs a portion of the watering liquid according to its absorption capability and disgorges a portion into the wall 36. Since the wall 36 comprises a porous ceramic material, the watering liquid passes through this material and goes to fill the control tank 34.

The watering liquid may also reach the control tank 34 through orifices 66. According to one variant of the present embodiment, the orifices 66 are not present and the watering liquid flows only by the porosities of the wall 36.

The wall 36 is thus able to absorb a portion of watering liquid and to drain it into the control tank 34.

On the other hand, thanks to its supporting rib 64 which lies in the control tank 34, the wall 36 can fill its pores with watering liquid by capillarity and diffuse the watering liquid into the control sample 62 as the latter sees its content of watering liquid (humidity, if the watering liquid is water) diminish. The porous wall 36 thus ensures a correlation between the content of watering liquid of the control sample 32 and the quantity of watering liquid present in the control tank 34.

The increase in the level of watering liquid in the control tank 34 produces a rising of the float 42 which is attached to the magnet 40. When the magnet 40 moves far enough away from the ferromagnetic needle 38, as previously described, the magnetic control valve 32 closes. Thus, it is the level of watering liquid in the control tank 34 which determines the opening and the closing of the magnetic control valve 32 and, hence, the opening and the closing of the fluidic control valve 11 and thus the watering of the farming soil. Now, since the level of watering liquid in the control tank 34 is correlated with the need for watering of the sample of the environment 32 thanks to the porous ceramic wall 36, the watering of the farming soil is controlled by the need for watering of the control sample 62.

One may thus break down an operating sequence of the watering system 10 in the following way.

The float 42 is positioned at its lowest level. In this position, the magnetic control valve 32 is open and the watering of the farming soil is activated. In parallel with this, the sample 62 receives water via the dripper 78. A portion of this water is absorbed by the sample 62, while the surplus fills the control tank 34 and causes the float 42 to rise. When the latter is high enough, the watering is halted.

The quantity of surplus water accumulated in the control tank 34 simulates the water reserve present in the subsoil of the farming soil, which makes it possible to rehydrate the surface layers of the soil as they become dry.

After the halting of the watering, the water contained in the control sample 62 is progressively used up by absorption of the plants in the environment or by evaporation. As this occurs, the porous wall 36 diffuses into the control sample 62 the water which it pumps by capillary action into the control tank 34. As long as the sample 62 and the wall 36 are not dry, water remains in the control tank 34 and a watering cycle is not initiated, since the magnet of the float remains above the needle.

Then, when all the water has been used up, the float 42 again descends and triggers a new watering cycle. Thus, a new watering sequence starts when the control sample 62 is dry. Now, since the control sample 62 is of the same nature as the soil being watered, the watering is initiated when the soil being watered is likewise dry.

By the same token, when the control sample has imbibed sufficient water, the wall 36 drains a portion of the surplus watering liquid into the control tank 34, putting an end to a watering sequence.

Moreover, in the case of a watering with water and an uncovered farming soil, rain water is poured into the control tank 34 and causes an elevation of the float 42 and the halting of the watering in the same way as described above.

The control tank 34 is thus able to move the magnetic control valve 32 from the closed position to the open position and vice versa, depending on the actual need for water in the environment to be watered.

Moreover, a portion of the watering liquid leaving the outlet 46 of the magnetic control valve does not pass through the watering duct 76, but rather reaches the fluid outlet 14 via the watering rate maintaining duct 80. This duct 80 makes it possible to maintain a minimal flow rate in the magnetic control valve 32 despite the presence of the dripper 78 and its possible very low flow rate setting.

Furthermore, as can be seen in FIG. 1, the control tank 34 is designed to allow the evacuation of rain water by virtue of the fact that its lateral wall 70 does not exceed the height of the supporting rib 64. The surplus rain water reaching the inside of the container 60 is thus drained into the control tank, from whence it is evacuated by overflow from the control tank 34. This arrangement makes it possible to guarantee that the control tank 34 never contains more than the equivalent of the water quantities available in the near sub-layers of the ground being watered.

Moreover, at its upper end, in a vertical direction, the sheath 72 comprises an orifice 82 designed to allow the evacuation of air present in the control tank 34. Thus, air does not accumulate in the control tank and cannot influence the displacement of the float 30, since it is evacuated from the orifice 82 and in the gap 84 existing between the sheath 72 and the case 56 of the watering control valve 32 and arrives in open air beneath the bottom 68 of the control tank 34.

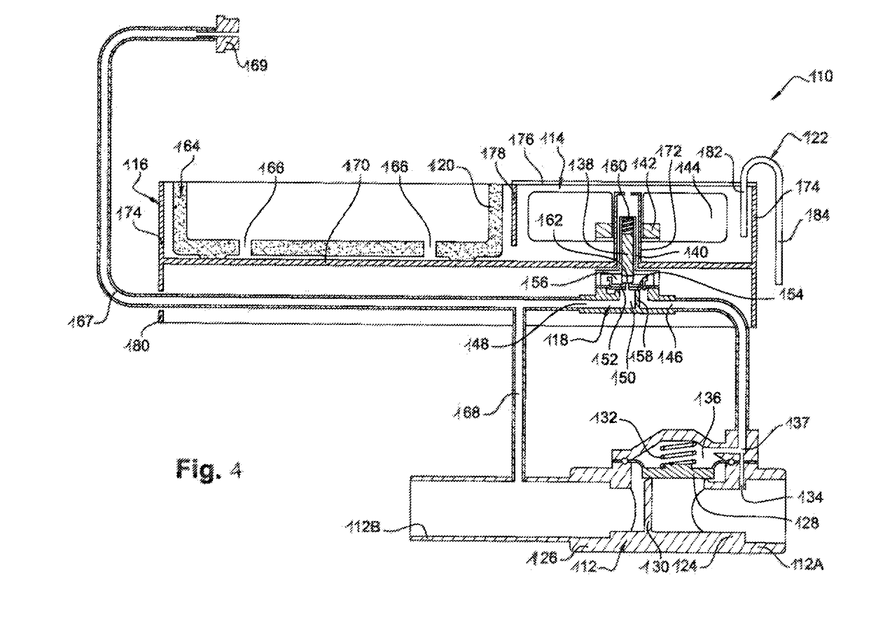

We shall now describe FIG. 4 in which an autonomous watering control device 100 according to a second embodiment is described, being designed to water an environment such as farming soil with water.

The autonomous watering control device 100 comprises:
a fluidic control valve 112 and
an autonomous device for watering 114.

The autonomous device for watering 114 comprises:
a control tank 116,
a magnetic control valve 118 able to move from a closed position to an open position and vice versa, according to the filling level of the control tank 116,
a porous ceramic wall 120, able to be in contact with the environment to be watered, or as can be seen in this embodiment with a sample of the environment to be watered, and separating the control tank 116 from said environment to be watered, the ceramic being structured to drain a watering liquid between the environment to be watered and the control tank 116, and
means of evacuation of watering liquid from the control tank 116.

Here, the valve 118 is a magnetic control valve. According to variants of the present embodiment, the valve 118 is a pneumatic control or a hydraulic control valve. In general, one may use any type of valve in the context of the invention.

In this embodiment, the means of evacuation of watering liquid from the control tank 116 comprise a siphon 122, which shall be described in detail below.

It will be noted furthermore that it is likewise possible not to have the sample of the environment to be watered present in the porous ceramic wall 120. In fact, the ceramic element itself is enough to reproduce the hydrological demand of the environment to be watered.

The fluidic control valve 112 comprises a fluid inlet 112A and a fluid outlet 112B. The fluid inlet 112A and the fluid outlet 112B are also a fluid inlet and a fluid outlet for the autonomous watering control device 100. The fluid inlet 112A is connected to a water intake (not shown) and the fluid outlet 112B is connected to a water outlet (not shown), such as a sprinkler, able to water the farming soil.

Between the fluid inlet 112A and the fluid outlet 112B, the fluidic control valve 112 comprises an upstream duct 24 and a downstream duct 126, which are formed here as a single piece with the inlet 112A and the outlet 112B, although this is in no way limiting.

Between the upstream duct 124 and the downstream duct 126, a tight membrane 128 rests against a seat 130. A spring 132 pushes the tight membrane 128 against its seat 130. In a branch from the upstream duct 124, a duct 134 leads to a chamber 136 delimited by the tight membrane 128 and in which the spring 132 is disposed. Moreover, the duct 134 is connected to a control outlet 137 of the fluidic control valve 112.

The magnetic control valve 118 shall now be described in further detail.

The magnetic control valve 118 comprises a ferromagnetic needle 138 able to move by axial translation in a case 140, a magnet 142 attached to a float 144, a fluid inlet 146, a fluid outlet 148, a fluid circulation duct 150 connecting the fluid inlet 146 and outlet 148, and a shutter formed by a shutter cup 152 coupled to an annular sealing membrane 154, whose periphery is clamped in the wall of the fluid circulation duct 150.

The sealing membrane 154 delimits, above the fluid circulation duct 50, a pressure chamber 156. The shutter, that is, the cup 152 coupled to the sealing membrane 154, is able to move by translation in the axial direction of the ferromagnetic needle 138 and the sealing membrane 154 rests against a seat 158, in one of the end travel positions of the shutter.

Moreover, a spring 160, arranged in the case 140, exerts pressure on the ferromagnetic needle 138 so that the latter bears against the shutter cup 152 and applies the sealing membrane 154 against the seat 158, so as to prevent the watering liquid coming from the fluid inlet 146 from reaching the fluid outlet 148.

The shutter cup 152 and the sealing membrane 154 comprise:
a first pressure equalizing duct of small diameter which establishes a fluidic communication between the lower and upper faces of the sealing membrane 154, that is, between the fluid inlet 146 and the pressure chamber 156; and
a second pressure equalizing duct 162 of larger diameter than the first pressure equalizing duct, which establishes a fluidic communication between the lower and upper faces of the sealing membrane 154, that is, between the pressure chamber and the fluid outlet 148. This second duct 162 is situated opposite a lower end (in relation to the drawing) of the ferromagnetic needle 138. When the ferromagnetic needle bears against the shutter cup 152, its lower end plugs the second pressure equalizing duct 162, if not hermetically then at least so as to reduce its clearance so that the flow rate of watering liquid through this second pressure equalizing duct 162 becomes less than the flow rate of watering liquid in the first pressure equalizing duct. On the contrary, when the needle is distant from the shutter cup 152, the watering liquid may pass through the second pressure equalizing duct 162 at a flow rate greater than the flow rate of watering liquid through the first pressure equalizing duct.

When the magnet 142 is positioned at a distance from the ferromagnetic needle 138, the return force of the spring 160 predominates and the second pressure equalizing duct 162 is plugged by the lower end of the ferromagnetic needle 138. The shutter cup 152 is thus subjected on its lower and upper faces to the pressure of the watering liquid present in the fluid inlet 146, but since the quantity of watering liquid which can enter into the pressure chamber 156 (by the first duct) is greater than the quantity of watering liquid which can leave the pressure chamber 156 (by the second duct 162), the pressure which prevails above the membrane is greater than that which prevails below and the membrane is applied against its seat. The watering liquid thus cannot circulate from the fluid inlet 146 to the fluid outlet 148. This position of closure is stable, since the pressure difference is increased if the fluid outlet 148 remains open, because the lower surface of the membrane delimited by the seat 158 is no longer subjected to the pressure of the watering liquid.

On the contrary, when the magnet 142 is near the upper end of the ferromagnetic needle 138, the force of attraction of the magnet 142 predominates over the return force of the spring 160 and attracts the ferromagnetic needle 138. Said needle 138 moves away from the shutter cup 152 and frees up the second pressure equalizing duct 162. The quantity of watering liquid which can enter the pressure chamber 156 then becomes less than the quantity of watering liquid able to leave said pressure chamber 156, so that the pressure drops in the pressure chamber 156 and the sealing membrane 154 is detached from its seat. Thus, the watering liquid can pass through the magnetic control valve 118.

Moreover, the autonomous device for watering 114 comprises the porous ceramic wall 120, which forms a container 164 surrounding and making contact with a control sample of the environment to be watered, here, a sample of farming soil. The porous ceramic making up the wall 120 has a mass by volume between 1.5 and 2 g/cm³, a crushing resistance of at least 15 MPa, a hardness at least equal to 5 Mohs, a water absorption capacity of at least 25 vol. %, a porosity at least equal to 40%, and it has pores with a diameter between 10 and 500 μm. The control sample is a portion of the farming soil at the surface or at a greater depth. Moreover, the container 164 has the shape of a pot or a pot holder. It also comprises, on its lower horizontal face, a plurality of orifices 166 whose function shall be described later on.

The autonomous device for watering 114 likewise comprises a watering duct 167 disposed at the outlet 148 of the magnetic control valve 118. In this embodiment, a dripper 169 is positioned at the other end of the watering duct 167, above the container 164. Moreover, the autonomous device for watering 114 has a watering flow maintaining duct 168 which is disposed in a branch from the watering duct 167 to the fluid outlet 112B of the fluidic control valve 112. The outlet flow rate of watering liquid of the dripper 169 can be regulated, for example, by means of a nut and screw assembly. Thus, if the dripper 169 is closed, the watering liquid is never sent to the container and the need for watering liquid is considered to be continual. Thus, the watering will also be continual. On the other hand, if the dripper 169 is adjusted at its maximum flow rate, the container will be quickly filled and the end of watering condition will be quickly reached. Between these two extreme configurations, the dripper 169 is able to insert a greater or lesser interval between the change in the hydrological conditions of the environment to be watered and the hydrological conditions of the sample. Thus, it is a supplemental means of adding flexibility to the watering conditions.

The control tank 116 comprises a horizontal main wall 170 which supports the container 164 and, arranged near the container 164, a sheath 172 which accommodates the case 140 of the ferromagnetic needle 138 and which serves as a guide for the float 144 containing the magnet 142, for its sliding in translation along the vertical direction. The control tank 116 also comprises an upper peripheral vertical wall 174, an upper horizontal wall 176 covering only the float 144 of the magnetic control valve 118, and a vertical wall 178, connected to the upper horizontal wall 176, which partially establishes a separation between the container 164 and the float 144 and which defines, with the upper peripheral vertical wall 174 and the upper horizontal wall 176, a refill chamber for watering liquid in which the float 144 can move in the vertical direction. The upper horizontal wall 176 furthermore comprises an orifice which makes it possible to introduce the siphon 122. The control tank 116 also has a lower vertical wall 180 which accommodates the shutter cup 152, the sealing membrane 154, the seat 158, the fluid inlet 146 and the fluid outlet 148 of the magnetic control valve 118.

As can be seen in FIG. 4, the container 164 and the magnetic control valve 118 are disposed side by side, are of the same height, and are aligned in the horizontal direction. Thus, the footprint of the autonomous watering control device 110, in the vertical direction, is reduced to 10 cm, without this height being in any way limiting. It is thus possible to bury the autonomous watering control device 110, which improves the aesthetics of the environment to be watered. Moreover, the autonomous watering control device 110 is thus protected against acts of vandalism, which is useful for example in the case of irrigation of public facilities.

In FIG. 4, the positioning of the valve in the drawing beneath that of the autonomous device should not be construed as meaning that the valve needs to be installed below the device.

The siphon 122 comprises a first portion 182 situated in the refill chamber near the float 144 and a second portion 84 whose one free end hangs outside the refill chamber, outside the autonomous watering control device 110. Furthermore, according to one variant, the first portion 182 of the siphon 122 is disposed near the porous ceramic wall 120. In this way, the float 144 is not liable to collide with the first portion 182 of the siphon 122 as it moves along the vertical direction. The siphon 122 comprises a material able to drain the watering liquid accumulating in the refill chamber by capillary action. In this embodiment, the siphon 122 comprises a wick of hydrophilic textile fabric. The difference in altitude between a free end of the first portion 182 and the free end of the second portion 184 is adjustable by sliding the siphon 122 in the orifice of the upper horizontal wall 176. To do so, one may optionally insert the siphon 122, at least partially, into a sheath making it possible to slide the siphon 122 in the orifice of the upper horizontal wall 176 without damaging the siphon 122 by friction. Furthermore, the flow rate of the watering liquid leaving the siphon is adjustable by means of clamping or squeezing, such as those controlled by an adjustment screw.

We shall now describe the functioning of the autonomous watering control device 110 and the autonomous device for watering.

The control outlet 137 of the fluidic control valve 112 is connected to the fluid inlet 146 of the magnetic control valve 118. Thus, it is the magnetic control valve 118 which controls the opening and the closing of the fluidic control valve 112. In fact, when the fluid outlet 148 of the magnetic control valve 118 is closed, the watering liquid coming from the fluid inlet 112A of the autonomous watering control device 110 flows into the chamber 136 of the fluidic control valve 112 where it exerts a pressure on the membrane 128 so as to close the fluidic control valve 112. On the contrary, when the fluid outlet 148 of the magnetic control valve 118 is open, the pressure of the watering liquid in the chamber 136 of the fluidic control valve 112 drops, resulting in the opening of the fluidic control valve 112. In this latter configuration, the watering liquid coming from the fluid inlet 112A of the autonomous watering control device 110 can again join the fluid outlet 112B of the autonomous watering control device 110. The watering liquid thus flows into the fluidic control valve 112 from the water intake, such as a reservoir (not shown) intended for the irrigation of the soil, up to the water outlet, such as a sprinkler (not shown), in order to water the agricultural soil.

Thus, it is the magnetic control valve 118 which controls the start and end of the flow in the fluidic control valve 112 and thus the start and end of a watering sequence. The magnetic control valve 118 is thus able to occupy a closed position, in which the watering is prevented, and an open position, in which the watering is enabled.

During a watering sequence, the magnetic control valve 118 is in the open position. In this case, the watering duct 167, which is connected to the fluid outlet 48 of the magnetic control valve 118, empties watering liquid through the dripper 169 into the control sample contained by the porous ceramic wall 120. The control sample absorbs a portion of the watering liquid according to its absorption capability and disgorges a portion into the wall 120. Since the wall 120 comprises a porous ceramic material, the watering liquid passes through this material and goes to fill the refilling chamber.

Here, the orifices 166 make it possible to diminish the absorption capacity of the container 164. According to one variant of the present embodiment, the orifices 166 are not present.

The wall 120 is thus able to absorb a portion of watering liquid and to drain it into the refill chamber.

On the other hand, the wall 120 can refill its pores with watering liquid by capillary action and diffuse the watering liquid into the control sample as the latter sees its content of watering liquid (humidity, if the watering liquid is water) diminish. The porous wall 120 thus ensures a correlation between the content of watering liquid of the control sample and the quantity of watering liquid present in the control tank 116.

The increase in the level of watering liquid in the refill chamber produces a rising of the float 144 which is attached to the magnet 142. When the magnet 142 moves far enough away from the ferromagnetic needle 138, as previously described, the magnetic control valve 118 closes. Thus, it is the level of watering liquid in the refill chamber of the control tank 116 which determines the opening and the closing of the magnetic control valve 118 and, hence, the opening and the closing of the fluidic control valve 112 and thus the watering of the farming soil. Now, since the level of watering liquid in the refill chamber of the control tank 116 is correlated with the need for watering of the sample of the environment thanks to the porous ceramic wall 120, the watering of the farming soil is controlled by the need for watering of the control sample.

However, especially when the environment to be watered comprises a draining substrate such as rock wool or coconut fiber, it may be necessary to shorten the time elapsed between two watering sequences. Thus, in parallel with the evaporation (when the watering liquid is water) in the control sample, in the porous ceramic wall 120 and in the refill chamber, the siphon 122 accelerates the evacuation of the watering liquid from the refill chamber of the control tank 116. The evacuation of the watering liquid is as fast as the difference in altitude between the free end of the first portion 812 and the free end of the second portion 184 is large. When these two free ends are at the same altitude or when the free end of the first portion 182 is at a lower altitude than the free end of the second portion 184, there is no evacuation of watering liquid from the control tank 116 other than that caused by evaporation. On the other hand, when the free end of the first portion 182 is at a higher altitude than the free end of the second portion 184, the watering liquid is evacuated from the control tank 116 at a flow rate which is as great as the altitude difference is large.

Moreover, the start of the evacuation of watering liquid from the control tank 116 depends on the altitude of the free end of the first portion 182 of the siphon 122. In fact, in order for the watering liquid contained in the refill chamber to start being evacuated, it is necessary for the level of watering liquid to be such that the free end of the first portion 182 of the siphon 122 is dipped into the watering liquid. Thus, by adjusting the altitude of the free end of the first portion 182 of the siphon 122, one regulates a refill volume defining a threshold such that the means of evacuation of the watering liquid from the control tank 116, here, the siphon 122, are able to evacuate the watering liquid from the control tank 116 when the volume of watering liquid in the control tank 116 passes a predetermined refill threshold.

One may thus break down an operating sequence of the watering system 110 in the following way.

The float 144 is positioned at its lowest level. In this position, the magnetic control valve 118 is open and the watering of the farming soil is activated. In parallel with this, the sample receives water via the dripper 169. A portion of this water is absorbed by the control sample, while the surplus fills the control tank 116, and especially the refill chamber, which causes the float 144 to rise. When the latter is high enough and reaches a closure position of the magnetic control valve, the watering is halted. The quantity of surplus water accumulated in the control tank 116 simulates the watering liquid reserve present in the farming soil, which makes it possible to rehydrate the surface layers of the soil as they become dry, when the watering liquid is water.

After the halting of the watering, the water contained in the control sample is progressively used up by absorption of the plants in the environment, by evaporation, and/or by evacuation from the control tank 116. As this occurs, the porous wall 120 diffuses into the control sample the water which it pumps by capillary action into the control tank 116. As long as the control sample and the wall 120 are not dry, water remains in the control tank 116 and a watering cycle is not initiated, since the magnet 142 of the float 144 remains above the needle.

Then, when all the water has been used up, the float 144 again descends and triggers a new watering cycle. Thus, a new watering sequence starts when the control sample is dry enough. Now, since the control sample is of the same nature as the soil being watered, the watering is initiated when the soil being watered is likewise dry enough or in any case is drying up. By the same token, when the control sample has imbibed sufficient water, the wall 120 drains a portion of the surplus watering liquid into the control tank 116, and especially the refill chamber, putting an end to a watering sequence. The control tank 116 is thus able to move the magnetic control valve 118 from the closed position to the open position and vice versa, depending on the actual need for water in the environment to be watered.

Moreover, a portion of the watering liquid leaving the outlet 148 of the magnetic control valve 118 does not pass through the watering duct 167, but rather reaches the fluid outlet 112B via the watering rate maintaining duct 168. This duct 168 makes it possible to maintain a minimal flow rate in the magnetic control valve 118 despite the presence of the dripper 169.

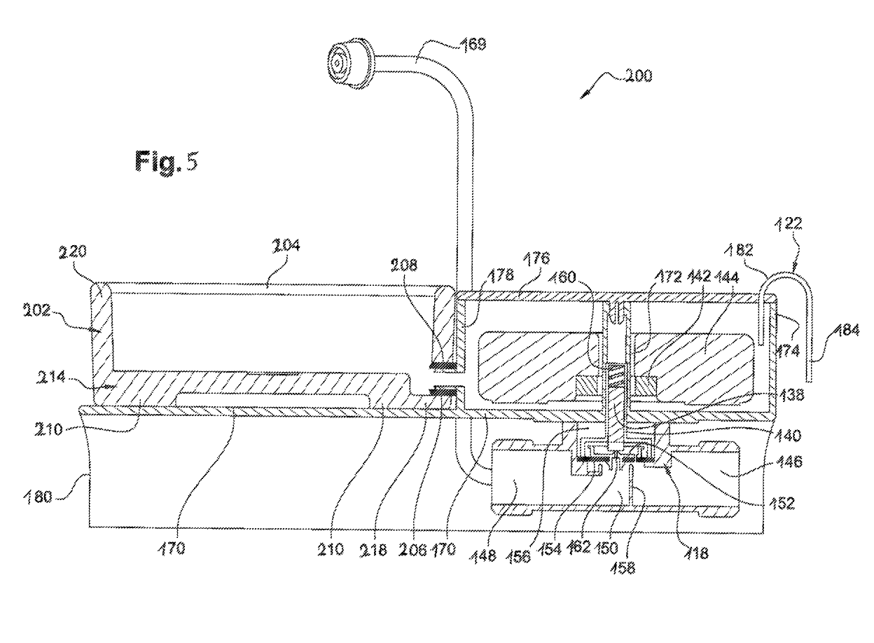

There is represented in FIG. 5 a third embodiment of the invention. Only the differences from the second embodiment will be described explicitly. The numerical references of the elements common to the second and third embodiments are unchanged. Only the upper portion of the autonomous watering control device 200 is represented, that is, the autonomous device for watering 214.

Several porous ceramic walls 220, whose properties are similar to those described above, form a retention tank 202 for watering liquid. The retention tank 202 is optionally covered by a lid 204 designed to prevent the pluviometry from impacting the direct refilling of the retention tank 202.

The retention tank 202 moreover comprises an orifice delimited by a contour 218. Likewise, the vertical wall 178, which helps delimit the refill chamber for watering liquid in which the float 144 is able to move in the vertical direction, comprises an orifice delimited by a contour 206 so as to establish a communication duct for watering liquid between the retention tank 202 and the refill chamber for watering liquid.

In order to ensure the tightness of the autonomous watering control device 200, a seal 208 is arranged between the contours 218 and 206 which define the duct enabling the communication of watering liquid.

The retention tank 202 rests on two feet 210 which themselves rest on the main horizontal wall 170. In this way, there is defined between the two feet 210 and a lower horizontal wall of the retention tank 202 a space ensuring a circulation of air and thus enabling increased evaporation of the watering liquid absorbed by the retention tank 202, comprising the porous ceramic material.

One of the advantages of this third embodiment is that, since the retention tank 202 comprises the porous ceramic material, it is directly in contact with the environment to be watered. Thus, it has a behavior in terms of evaporation of the watering liquid which is even closer to that of the environment to be watered.

In this third embodiment, as in the second, one sees that a control sample of soil is not indispensable and that the porous ceramic material may suffice. In particular, the different settings made possible by the siphon 122 facilitate the precise adjustment of the device, without the presence of a control sample of soil.

Moreover, it will be noted that one may use the autonomous device for watering 214 without having a control valve as previously described. In fact, the autonomous device for watering 214 can be connected directly to a fluid inlet connected to a reservoir of watering liquid, for example, and to a fluid outlet connected to a sprinkler, for example.

It will be understood that certain components or structures described in the context of one embodiment may likewise be present in the device according to the other two embodiments. For example, the means of evacuation of the watering liquid such as the siphon 122 described in the context of the second and third embodiments may equally be provided in the device of the first embodiment, as can the horizontal arrangement of the container 164 and the valve 118.

Numerous other modifications can be made to the invention without leaving its scope.

One may use any type of means for evacuation of the watering liquid from the control tank 116. For example, one could use a pipe, possibly associated with a tap to allow an operator to manually adjust the evacuation flow rate of watering liquid.

Moreover, one may use any type of watering liquid and in particular an aqueous solution containing mineral salts.

Furthermore, as is seen in FIGS. 1 and 4, the sheath 72, 172 has an orifice at its upper end, in the vertical direction, to enable the evacuation of air present in the control tank 34, 116. Optionally, the sheath 72, 172 does not have this orifice.

1. An autonomous device for watering an environment to be watered, comprising:
a control tank,
a valve that can switch from a closed position to an open position and vice versa, according to the filling level of the control tank, and
a porous ceramic wall that can be in contact with the environment to be watered and separating the control tank from said environment to be watered, the ceramic wall being structured so as to drain a watering liquid between the environment to be watered and the control tank.

2. The device as claimed in claim 1 which allows for evacuation of the watering liquid from the control tank.

3. The device as claimed in claim 2, wherein the autonomous device evacuates the watering liquid from the control tank when a volume of watering liquid in the control tank exceeds a predetermined filling threshold.

4. The device as claimed in claim 3 wherein the autonomous device enables regulation of the predetermined filling threshold of watering liquid in the control tank.

5. The device as claimed in claim 2, wherein the control tank is evacuated via a pipe.

6. The device as claimed in claim 2, wherein control tank is evacuated by a siphon.

7. The device as claimed in claim 6, wherein the siphon comprises a material able to drain the watering liquid by capillarity.

8. The device as claimed in claim 6, wherein a difference in altitude between two ends of the siphon is controllable.

9. The device as claimed in claim 1, wherein the porous ceramic wall forms a container that can receive the environment to be watered.

10. The device as claimed in claim 1, wherein the container and the valve are disposed side by side.

11. The device as claimed in claim 1, wherein the valve is a magnetic control valve comprising a ferromagnetic needle and a magnet attached to a float.

12. The device as claimed in claim 11, wherein the valve comprises a case to hold the ferromagnetic needle and the control tank comprises a sheath that can receive the case while serving as a guide for the sliding of the float.

13. The device as claimed in claim 12, wherein the control tank comprises a wall which supports the container and forms the sheath.

14. The device as claimed in claim 12, wherein the sheath has an air evacuation orifice.

15. The device as claimed in claim 1, wherein the control tank is designed to evacuate rain water.

16. The device as claimed in claim 1, comprising a watering duct disposed between an outlet of the valve and the container.

17. The device of claim 1 being a autonomous device for controlling the watering further comprising:
a fluidic control valve that can occupy a closed position in which the watering is prevented and an open position in which the watering is enabled, depending on the flow rate of a watering liquid in a control outlet of said fluidic control valve, and the
autonomous device for watering is applied to a control sample of the environment to be watered, fed by the control outlet of the fluidic control valve.

18. The device of claim 17 wherein, wherein the autonomous device for watering comprises a watering duct and the autonomous device for controlling the watering comprises a watering rate maintaining duct, situated between the watering duct and a watering flow outlet duct of the fluidic control valve.

19. The device as claimed in claim 7, wherein a difference in altitude between two ends of the siphon is controllable.

20. The device of claim 10 wherein the container and the valve are at the same height and aligned in a horizontal direction.

21. The device of claim 16 wherein watering duct comprises a dripper
